(19) United States
(12) Patent Application Publication
(10) Pub. No.: US 2006/0032499 A1
(43) Pub. Date: Feb. 16, 2006

(54) Exhalation system

(75) Inventor: Odd Halsnes, Bastad (NO)

Correspondence Address: CONNOLLY BOVE LODGE & HUTZ LLP, SUITE 800, 1990 M STREET NW, WASHINGTON, DC, 20036-3425, US

(73) Assignee: Forsvarets Forskningsinstitutt, Kjeller (NO)

(21) Appl. No.: 10/533,129

(22) PCT Filed: Oct. 28, 2003
(86) PCT No.: PCT/NO03/00358

§ 371 Date: Apr. 29, 2005

(30) Foreign Application Priority Data
Oct. 31, 2002 (NO) 20025231

(51) Int. Cl. A62B 18/00; A62B 18/10

(52) U.S. Cl. 128/201.24; 128/207.12; 128/206.28

(57) ABSTRACT

An exhalation system is provided for a helmet or face mask, which helmet or face mask covers the whole or parts of the area of the face's exhalation organs, the nose and mouth, with a chin guard. The system is characterised in that the chin guard is provided with an internal closed cavity which has an opening towards the interior of the helmet or the face mask on the inside of the chin guard and an additional opening towards the outside of the chin guard. The opening towards the interior of the helmet is relatively large and is in the form of one large opening or a small number of large openings which offer the least possible resistance and maintain the velocity of the exhalation air in the best possible manner.

The present invention relates to an exhalation system for a helmet or face mask, which helmet or face mask covers the whole or parts of the area of the face's exhalation organs, nose and mouth.

People using helmets of various types or different kinds of face masks, particularly with visors or goggles, are familiar with the problems that arise when exhaled air from the person's exhalation organs such as the nose or mouth causes misting on glasses or visors together with a raised level of CO2 in the immediate vicinity of the area where the person breathes in. This makes it difficult to see and reduces visibility while at the same time a person who is physically active may experience increased levels of CO2 as a problem leading to a reduced state of alertness, nausea, dizziness and at worst a loss of consciousness. Exhalation in a closed helmet, moreover, creates unpleasant conditions with regard to odour, etc. inside the helmet.

The problem applies to motorcycle helmets and helmets for use by soldiers, police and security personnel, when the helmet covers the mouth and/or nose and particularly when the helmet has a visor or goggles. Such helmets are less able to replace air from the area round the nose/mouth.

A number of face masks are also employed which, in combination with a visor or goggles, create a space round the face which covers nose and mouth, thereby creating the same situation.

A number of helmets and face masks therefore have a perforated or otherwise partly open area at the nose and mouth to permit the escape of exhaled air. The problem, however, is that such perforated areas have relatively strong resistance and whilst the problem of moist exhaled air (which causes misting) may perhaps be solved since the exhaled air is mixed with and cooled by fresh air in front of the openings, there will be very little effect on problems with a raised concentration of CO2, since the resistance is too great to permit this gas to be removed.

Nor is it desirable to have a large opening in the protection round nose and mouth offered by a helmet or face mask. This is due to several factors, such as deficient protection (in the case of a motorcycle helmet, for example), unfavourable wind and weather conditions, particularly at high speed where snow and rain, etc. penetrate right into the person's breathing organ. This also results in a substantial reduction in comfort. When the air outside the helmet moves at a velocity against the helmet that is greater than the velocity of the air exhaled from nose or mouth, moreover, exhaled air will not be removed to a noticeable extent, but only attenuated in the nose or mouth region.

A number of solutions may also be envisaged where excess pressure is created in the helmet in order to assist in removing used air while simultaneously drawing in fresh air. Such systems, however, are expensive and technically sophisticated, with the result that they are also vulnerable.

As a rule the problem is how to expel the exhaled air while avoiding having an excessively large opening out of the mouthpiece/nosepiece which also acts as an entry point for moisture, etc. In addition it is important to carry exhaled air away from the area immediately round the nose and mouth since the inhalation air is drawn from this nearby area and there is a risk of exhaled CO2-rich air being breathed back in.

It is therefore an object of the present invention to provide a system for use in helmets or face masks covering the nose/mouth, which system permits the free passage of exhaled gases away from the face only by means of the natural velocity of the gases out of the nose or mouth. It is a further object to provide a system which can easily be adapted to the different helmets and face masks and which does not come into conflict with padding, the ability to tilt up a chin guard or the like.

Thus, based on the above-mentioned objects, an exhalation system is provided for a helmet or face mask, which helmet or face mask covers the whole or parts of the area of the face's exhalation organs, the nose and mouth, with a chin guard. The, system is characterised in that the chin guard is provided with an internal closed cavity which has an opening towards the interior of the helmet or the face mask on the inside of the chin guard and an additional opening towards the outside of the chin guard. The opening towards the interior of the helmet is relatively large and is in the form of one large opening or a small number of large openings which offer the least possible resistance and which maintain the velocity of the exhalation air in the best possible manner.

In an alternative embodiment the chin guard is composed of two parallel plates with an intermediate cavity where the cavity is airtight at the upper edge, thus preventing exhaled air from moving up from the cavity (it is a well-known fact that hot air rises).

In a further embodiment the cavity in the chin guard has an opening in the lower edge of the chin guard for venting exhaled air. This provides amongst other advantages a short ventilation path.

In yet another embodiment the venting of exhaled air can be implemented, for example, on the side of the chin guard through one or more openings. This embodiment has the added advantage that a slight negative pressure can be created on the sides which helps to “suck” out exhaled air when, for example, the air is moving past the exterior of the helmet at high speed.

In an alternative embodiment a respirator may be connected to the helmet, with the result that inhaled air is first purified or an excess pressure of “clean” air is established inside the helmet. In connection with the exhalation system, a respirator of this kind can be connected to the cavity in the chin guard. However, such a solution requires a good seal round the neck and back of the head as well as in the remaining parts of the helmet.

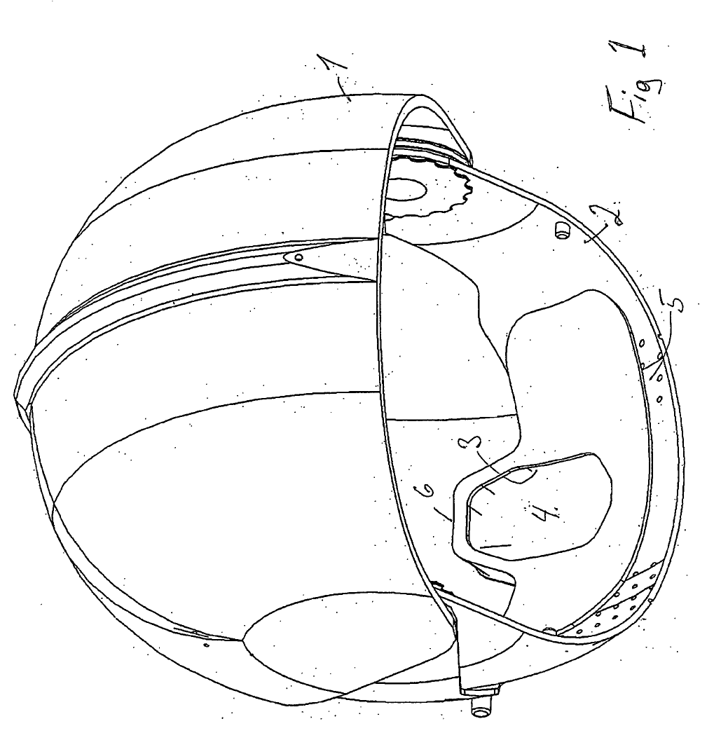

An example of a helmet with chin guard and exhalation system according to the present invention is further illustrated in FIG. 1. A helmet 1 is illustrated here in perspective from behind and partly below with a chin guard 2. The chin guard 2 also has a raised portion 6 at the exhalation organs, which is preferred in order to capture as much of the exhaled air as possible.

The chin guard 2 is further provided with a cavity 3 at the front edge with a large opening 4 from the inside of the helmet towards the cavity 3. The cavity 3 is airtight along its outer edge except for an opening 5 at the bottom where the exhaled air can be expelled freely.

The inhalation takes place in the immediate vicinity of the nose and mouth and will therefore not be affected to a noticeable extent by the exhaled air that has passed to the outside of the bottom of the helmet. If there is a relative difference in velocity between the helmet and the surrounding air, moreover, exhaled air which is passed down on the bottom of the chin guard will blow away or be attenuated.

The opening 4 into the cavity 3 is adapted in size and shape in order to maintain the natural velocity of the exhaled air and this air is then diverted from the immediate vicinity of the breathing organs.

1-4. (canceled)

5. An exhalation system suitable for use with a helmet or face mask and which covers at least a portion of a facial area including exhalation organs, the exhalation system comprising:
a chin guard, wherein the chin guard comprises an internal closed cavity which has at least one opening towards an interior portion of the helmet or the face mask,
wherein the cavity comprises one or more openings towards an outside portion of the chin guard.

6. An exhalation system according to claim 5, wherein the chin guard comprises two parallel plates with an intermediate cavity which is airtight at an upper edge thereof.

7. An exhalation system according to claim 5, wherein the cavity in the chin guard has an opening in a lower edge of the chin guard.

8. An exhalation system according to claim 6, wherein the cavity in the chin guard has an opening in a lower edge of the chin guard.

9. An exhalation system according to claim 5, wherein the cavity in the chin guard has one or more openings towards the outside portion of the chin guard located on a side of the chin guard.

10. An exhalation system according to claim 6, wherein the cavity in the chin guard has one or more openings towards the outside portion of the chin guard, on a side of the chin guard.
